(19) United States
(12) Patent Application Publication
(10) Pub. No.: US 2012/0285494 A1
(43) Pub. Date: Nov. 15, 2012

(54) Pet Waste Removal Device

(76) Inventor: Lawrence Orubor, Calgary (CA)

(21) Appl. No.: 13/514,028

(22) PCT Filed: Dec. 14, 2010
(86) PCT No.: PCT/IB10/55800

§ 371 Date: Jun. 5, 2012

Related U.S. Application Data
(60) Provisional application No. 61/286,068, filed on Dec. 14, 2009.

(51) Int. Cl. B08B 3/00

(52) U.S. Cl. 134/184

(57) ABSTRACT

A pet waste removal device including an elongated hand held boom having an open bottom shield disposed at a bottom end of the boom for positioning over a pile of animal waste. A motor driven agitator is disposed within the shield and driven by a motor to rotate between a counterclockwise and a clockwise rotation to mechanically break up pet waste. Fluid jet nozzles are supplied water via a garden hose connection and are arranged to direct water jets into the shield to wash away the pet waste as it is broken up by the agitator. A chemical dispenser for dispensing a chemical solution can also be provided.

### FIELD OF THE INVENTION

The present invention relates generally to pet waste removal devices, and more particularly, relating to a pet waste removal and disinfecting device for the removal of solid pet waste from a surface by a combination of powered agitation and treatment solution jet action.

### BACKGROUND OF THE INVENTION

Animal waste, particularly raw fecal material from dogs and other household pets are smelly and consist largely of numerous disease causing pathogens that pose potential health risks to pets and humans exposed to them. These disease causing pathogens found in fecal material also contaminates our soil, water and food grown in their vicinity. It is believed, the enormous volume of uncontrolled animal waste produced each year has significant impact on public health and the environment. Particularly, in the presence of accumulated waste in places such as backyards, public and private play grounds, including off leash parks. The presence of animal waste is considered an eye sore and a nuisance which must be eliminated.

### SUMMARY OF THE INVENTION

The preferred embodiments of the present invention addresses this need by providing a pet waste removal device that has an improved construction affording a combination of powered agitation and treatment solution flushing action to dispose of pet waste.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a diagrammatic, and partial cross-sectional, side elevation view of a first embodiment of a pet waste removal device constructed in accordance with the principles of the invention;

FIG. 2 is a is a diagrammatic bottom view of an agitator of the pet waste removal device;

FIG. 3 is a is a diagrammatic side view of the agitator;

FIG. 4 is a block diagram of an exemplarily electrical circuit comprising a power supply, a motor, a pump, a first electrical switch, and a second electrical switch;

FIG. 5 is the pet waste removal device of FIG. 1 shown in a mode of operation where the pet waste removal device is being operated to clean, sanitize and remove pet waste from a surface;

FIG. 6 is the pet waste removal device of FIG. 1 shown in a mode of operation where the pet waste removal device is being operated in a “self-clean” mode to clean, sanitize and remove any residual pet waste from the device;

FIG. 7 is a diagrammatic, and partial cross-sectional, side elevation view of a the pet waste removal device of FIG. 1 illustrating a second exemplary agitator driving assembly;

FIG. 8 is a diagrammatic, and partial cross-sectional, side elevation view of a second embodiment of a pet waste removal device constructed in accordance with the principles of the invention illustrating a second embodiment of an agitator;

FIG. 9 is a diagrammatic, a cross-sectional view taken along line 9-9 in FIG. 8;

FIG. 10 is a diagrammatic, and partial cross-sectional, side elevation view of a third embodiment of a pet waste removal device constructed in accordance with the principles of the invention illustrating a second embodiment of an agitator;

FIG. 11 is a diagrammatic, and partial cross-sectional, side elevation view of a fourth embodiment of a pet waste removal device constructed in accordance with the principles of the invention illustrating a second embodiment of an agitator;

FIG. 12 is a diagrammatic, and partial cross-sectional, side elevation view of a fifth embodiment of a pet waste removal device constructed in accordance with the principles of the invention illustrating a manually operated chemical pump;

FIG. 13 is an enlarged, diagrammatic and partial view of the pet waste removal device of FIG. 12;

FIG. 14 is an enlarged, diagrammatic and partial view of the pet waste removal device of FIG. 12 illustrating an alternative chemical container construction;

FIG. 15 is a diagrammatic, and partial cross-sectional, side elevation view of a sixth embodiment of a pet waste removal device constructed in accordance with the principles of the invention illustrating a granular material dispenser; and

FIG. 16 is an enlarged, diagrammatic and partial view of the pet waste removal device of FIG. 16.

### DETAILED DESCRIPTION OF THE INVENTION

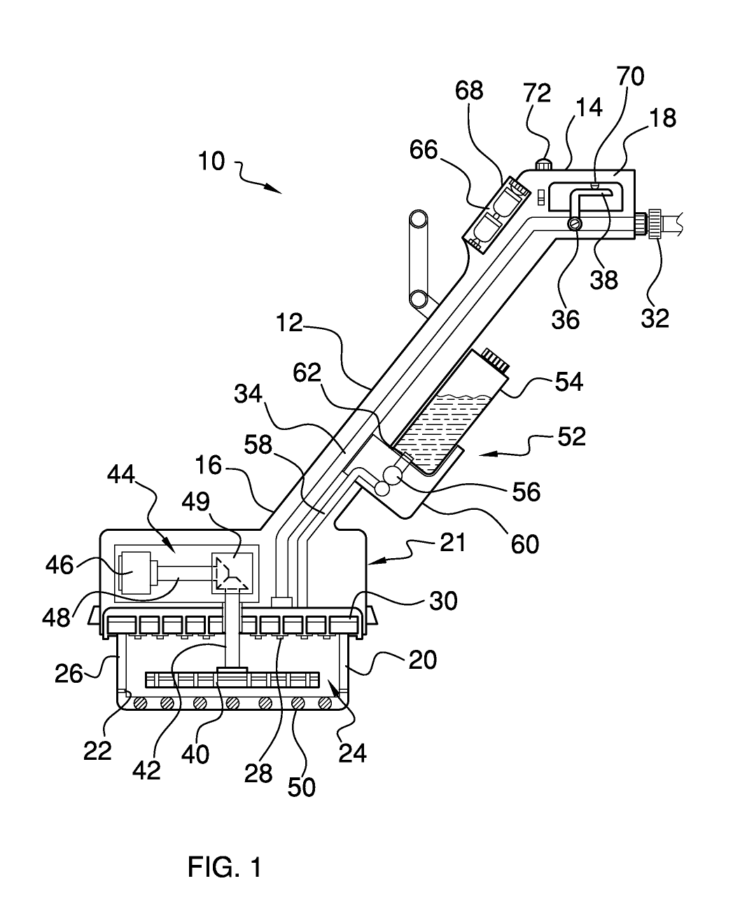

FIG. 1 is a diagrammatic, and partial cross-sectional, side elevation view of a first embodiment of a pet waste removal device 10 of the present invention. The pet waste removal device 10 is useful in the sanitizing and the disposal of animal waste, as will be come readily apparent from this disclosure. The pet waste removal device 10 includes an elongated boom 12 having an upper or first end 14 and lower or second end 16. Upper end 14 is configured to include a handle 18 for grasping by a user to operate the pet waste removal device 10.

A cleaning head 21 disposed at the lower end 16 of the boom 12 includes a shield or plenum 20 and is connected to be moved with the boom. The plenum 20 has an open bottom 22 and an open interior space 24 defined by sidewall 26. Open bottom 22 is positioned to be generally directed away from the upper end 14 of the boom 12. Plenum 20 is placed over a pile of pet waste and the device 10 is operated to sanitize and wash away the pet waste, as will be discussed further below.

Cleaning head 21, further includes one or more nozzles 28 providing jets or sprays of treatment solution for breaking up and flushing away the pet waste. One or more nozzles 28 are disposed and arranged to direct a jet of fluid or water in a generally downwardly direction towards the open bottom 22 of the plenum 20. The one or more nozzles 28 can be arranged to provide a crossing pattern of jets to impinge upon the pet waste at different angles to further aid in breaking up the waste. Further, one or more nozzles 28 can be arranged to provide jets to impinge upon the interior surface of sidewall 26 to flush waste from the sidewall. Further yet, one or more nozzles 28 can be arranged to provide jets to impinge upon the exterior surface of sidewall 26 to flush waste from the sidewall to sanitize and flush waste from the exterior surface of the sidewall.

Nozzles 28 are fluidically connected to an accumulator 30, which is further fluidically connected to a fitting 32, which may be a standard garden hose connector, by fluid carrying conduit 34. Accumulator 30 extends transversely across lower end 16 of boom 12. Conduit 34 carries supply water from a pressurized supply of water which may be a garden hose connected to a water spigot. Conduit 34 may be integrally formed with boom 12, or may be a ridge or flexible pipe or hose extending along and within the interior or along the exterior of boom 12. Valve 36 controls the flow of supply water through conduit 34 provided via fitting 32. Valve 36 may be a normal-closed valve and spring biased into the closed position. A trigger 38 is operatively connected to valve 36, and is graspable by the fingers of a user holding handle 18, whereby valve 36 is operated by squeezing ones hand.

Cleaning head 21 further includes, an agitator 40 is disposed within the interior space 24 of the plenum 20 and is operatively connected via shaft 42 to an agitator driving assembly 44. Agitator driving assembly 44 operates to rotate agitator 40 in alternating clockwise and counterclockwise rotational directions. Agitator driving assembly 44 includes an electric motor 46 operatively connected to shaft 42 for effecting alternating clockwise and counterclockwise rotational directions of agitator 40. One skilled in the art will readily recognize numerous different constructs that are suitable to operatively connect electric motor 46 to shaft 42 for rotate agitator shaft 42 in alternating clockwise and counterclockwise rotational directions, and thus agitator 40.

In a non-limiting example, the agitator driving assembly 44 may include an electric motor 46 operatively connected to horizontal shaft 48 for rotatingly driving shaft 48. Shaft 48 is connected to gear box 49 and provides rotational input thereto. Shaft 42 is connected to gear box 49 for receiving rotational output therefrom provided by shaft 48. The particular internal gearing of gear box 49 can be selected to increases or decrease either rotational speed or torque of shaft 42.

A plate 50 of open mesh grating extends across the open bottom 22 of plenum 20. The open mesh grating plate 50 prevents large solid objects from entering the interior space 24 of the plenum 20 that could possibly damage the agitator 40. The mesh size of plate 50 is sufficient to permit the passage of pet waste into the interior space 24 without mashing the pet waste into the ground. Plate 50 can be removably attached to the plenum 20 by mutual engagement between periphery of the plate and sidewall 26 of the plenum.

Further included is a chemical dispenser 52 including a fluid tank 54 for holding a quantity of fluid disinfectant and/or deodorizer to be admixed with supply water flowing through fluid conduit 34 to be dispensed from nozzles 28. As depicted, a pump 56 is operatively connected to fluid tank 54 to pump treatment solution therein through treatment solution fluid passage 58. Treatment solution fluid passage 58 is connected to the accumulator 30 such that treatment solution contained in fluid tank 54 can be pumped by pump 56 into the accumulator 30 to be admixed with supply water and to be dispensed through nozzles 28.

Alternatively, the solution fluid passage 58 can be connected to the fluid conduit 34 at a position upstream of the accumulator 30. The fluid tank 54 is adapted to be removably attached to the boom 12 by mutual engagement between the fluid tank 54 and cradle 60. Fluid tank 54 can include a seal 62 that is penetrated when inserted in cradle 60 to connect pump 56 to the fluid tank. The fluid tank 54 may further include a mouth having a removable lid to allow refilling of the fluid tank.

Alternatively, fluid solution passage 58 can be fluidically connected to separate nozzles for dispensing separately of supply water dispensed from nozzles 28. In this application, the treatment solution would be admixed with the supply water during the concurrent discharge of the treatment solution and supply water from separate nozzles.

A power supply 66, such as batteries are located in battery housing 68. Alternatively, the power supply 66 could be in the form of a single battery pack containing one or more batteries, could be in the form of electrical energy provided by a power cord plugged into a powered electrical outlet, or could be in the form of a fuel cell. Alternatively yet, as discussed below, power supply 66 may be provided by an electric generator.

In an aspect, electric motor 46 is connected to the power supply 66 and is operated by a first electrical switch 70. For ease of operation, switch 70 can be disposed to be conjointly operated with valve 36. For example, the trigger 38 of the valve 36 could be caused to press against and operate switch 70. In this configuration switch 70 may be a normally-closed momentary push button switch. In an aspect, pump 56 is connected to the power supply 66 and is operated by a combination of the first electrical switch 70 and a second electrical switch or pump master switch 72. When pump master switch 72 is selected into the on position or on state, pump 56 can be operated by electrical switch 70. When pump master switch 72 is selected into the off position or off state the pump 56 is not operable by electric switch 70. Alternatives are possible, for example a dial selector could be provided for selecting various mode of operations which are controlled a single electrical switch, such as electrical switch 70. Example modes of operation can include an agitator mode where only the electric motor 46 is operated, a treatment solution mode where only the pump 56 is operated, a combined agitator and treatment solution mode where both the pump and the electric motor are operated, or water mode where neither the pump or electric motor are operated.

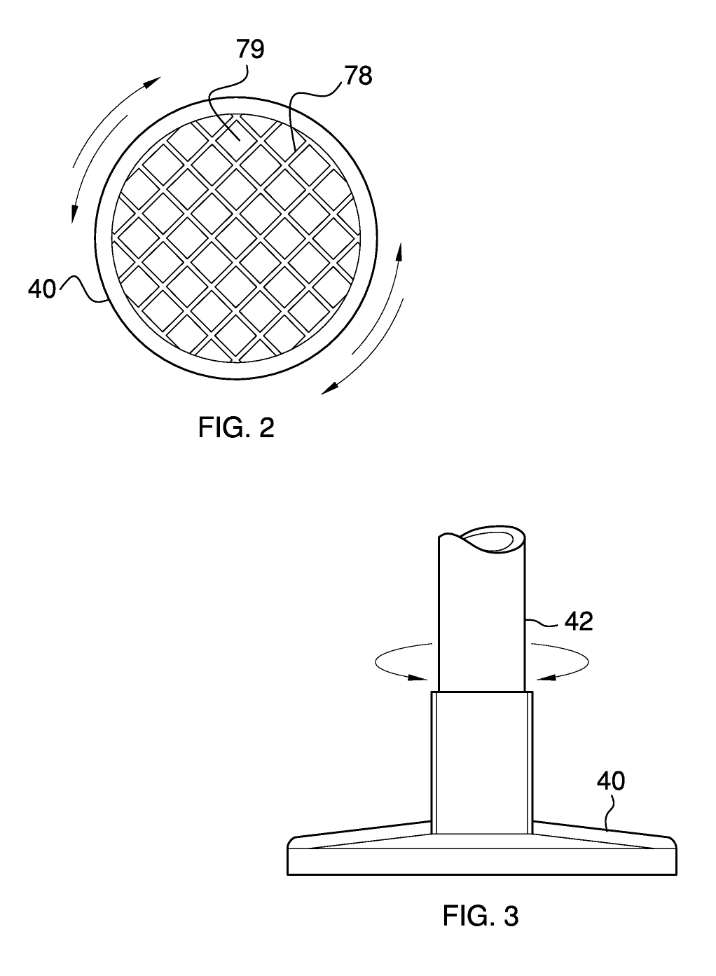

FIG. 2 is a diagrammatic bottom view of agitator 40. Agitator 40 includes an open mesh grid 78 with openings 79 extending vertically through the grid. In operation, pet waste is mechanically broken upon into smaller bits by a mashing action provided by the openings and the counterclockwise and clockwise rotation of the agitator 40. Jets of treatment solution from nozzles 28 are free to pass through openings the openings of the open mesh grid 78 to sanitize and flush waste from the openings and to further churn and breakup the waste.

FIG. 3 is a diagrammatic side view of agitator 40 and shaft 42. In an embodiment, shaft 42 is disposed within a collar extending from an upper surface of the agitator 40.

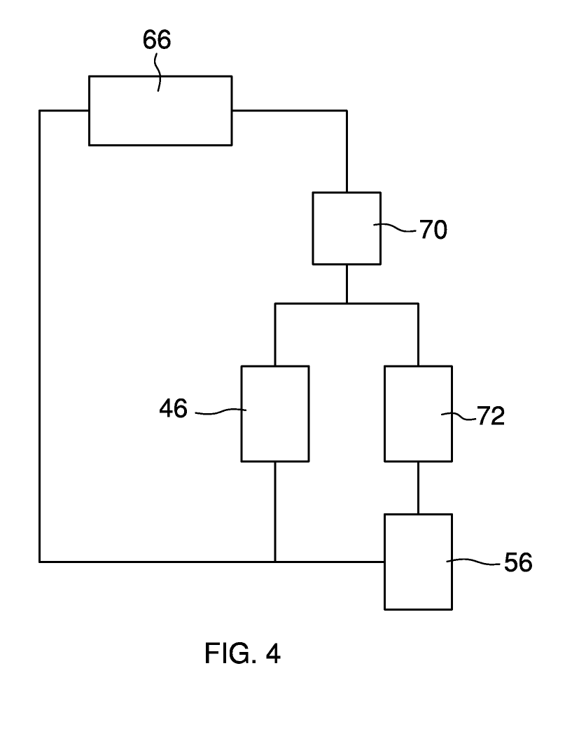

FIG. 4 is a block diagram of an electrical circuit comprising power supply 66, motor 46, pump 56, and switches 70 and 72.

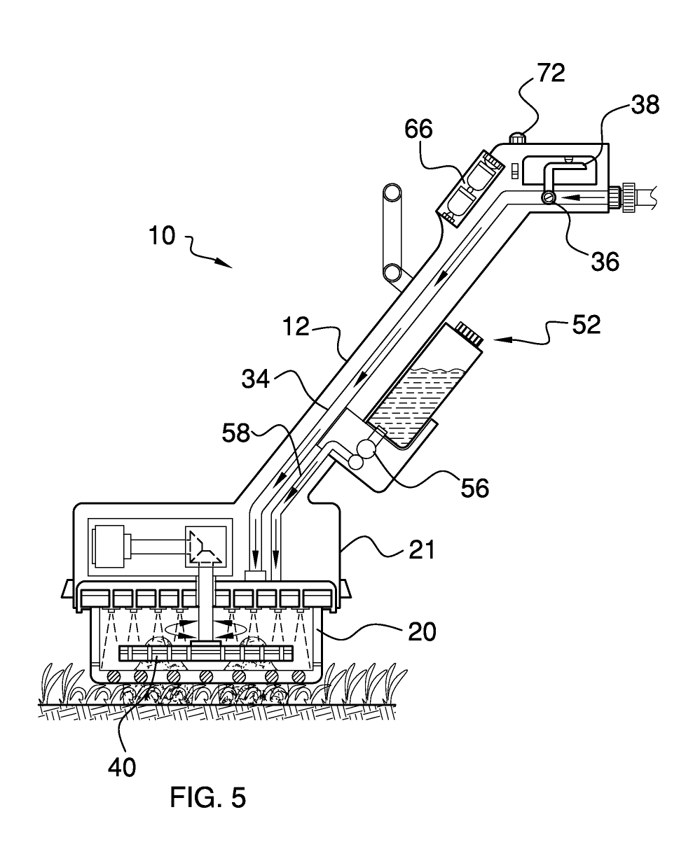

In operation, it can now be understood, to eliminate waste deposit the cleaning head 21 is placed over targeted waste with the waste shielded by plenum 20. Then the trigger 38 is pulled to open water supply valve 36 and to operate switch 70. In that, from a single pull of the trigger 38 the water supply valve 36 is open to permit water to enter the device, the pump 56 is operated and the agitator 40 is put into action simultaneously. Having pulled the trigger 38 supply water flows through fluid conduit 34 and into the accumulator 30, treatment solution is pumped from fluid tank 54 into the accumulator where it is admixed with supply water and discharged through nozzles 28. The treatment solution can include sanitizing, deodorizing and disintegrating ingredients and could also include desired fragrance. The combination of treatment solution jet from nozzles 28 and the motion of the agitator 40 works simultaneously together to dissolve confined fecal material into soluble liquid material the sanitizing ingredient of the solution kills harmful bacteria and neutralizes offensive odor associated with animal waste making the dissolved and treated waste safe for subsequent absorbent into the ground, as best seen in FIG. 5.

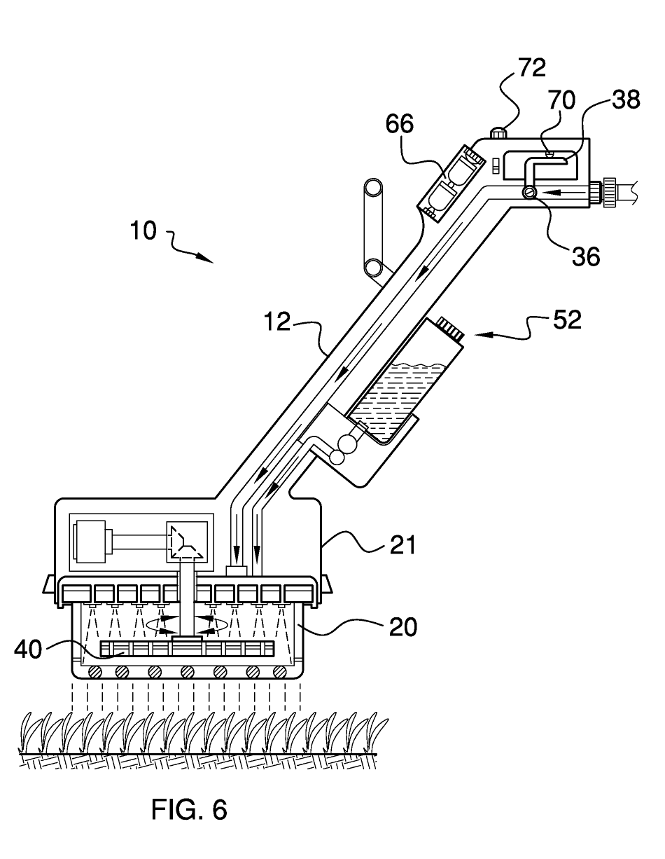

Having completely sanitized and dissolved targeted animal waste into soluble material. The operator raises the device 10 above the ground level and then operates electrical switch 72 to disconnect the pump 56 from the power supply 66 to stop the dispensing of treatment solution, and thus initiating a self-clean mode of operation, shown in FIG. 6. During self-clean mode only fresh water is being discharged through the nozzles 28 to rinse the sanitized surfaces of the plenum 20 and agitator 40. It is equally important that the agitator 40 remain in motion during the self-clean phase to facilitate the removal and discarding of unwanted material trapped within the agitator. To this end, the device 10 is completely cleaned from all harmful bacteria and odor associated with animal waste after use.

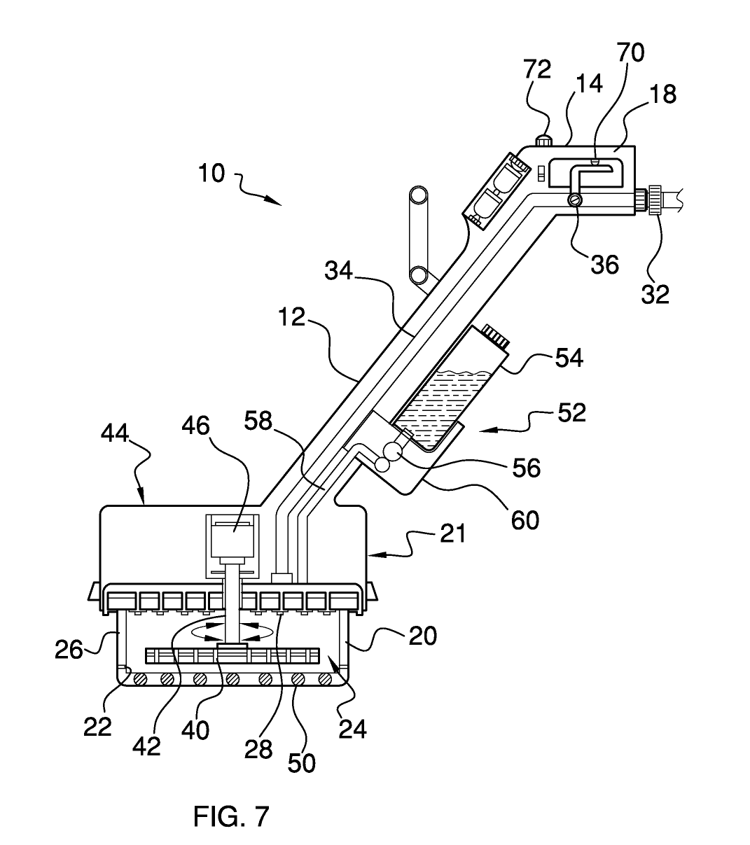

Alternative embodiments of the pet waste removal device 10 are possible. In FIG. 7, there is depicted an alternative exemplary agitator driving assembly 44′, including shaft 42 and electric motor 46. In this non-limiting example, shaft 48 of the first example depicted in FIG. 1 is removed, and the motor 46 is positioned coaxially with shaft 42.

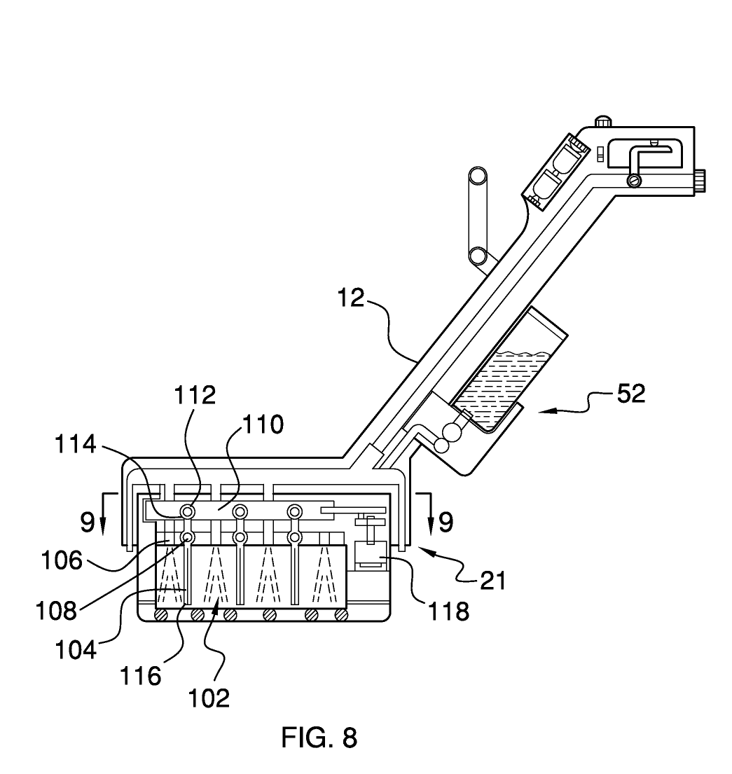

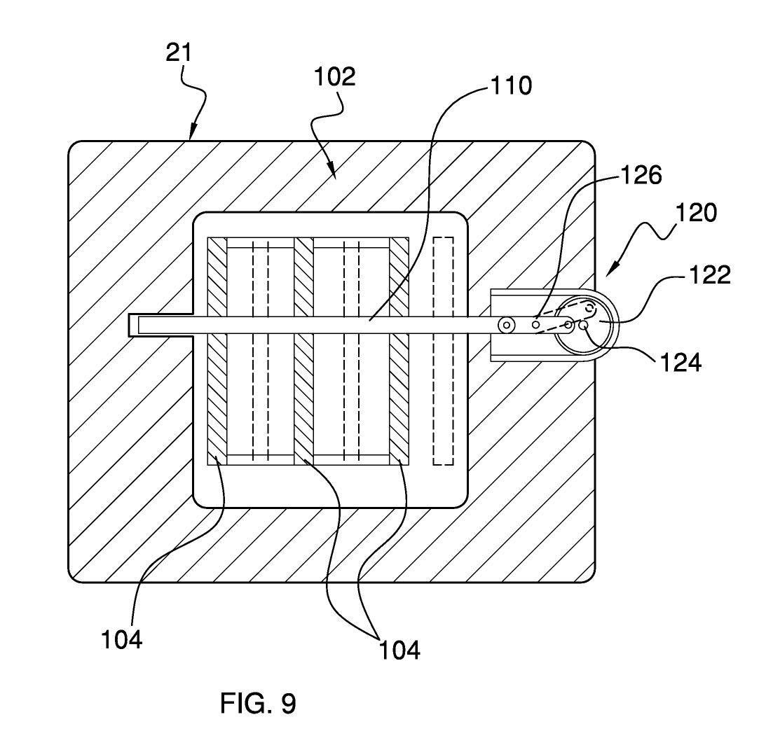

Yet additional alternative embodiments of the pet waste removal device 10 are possible. A second embodiment of the pet waste removal device 100 of the invention will be described below with reference to FIGS. 8 and 9. The same reference numbers, as employed in the first embodiment, will refer to the same parts, and explanation thereof in detail will be omitted here. In this embodiment, agitator 40 is replaced with agitator 102 comprising a plurality of vertically oriented and horizontally spaced tines 104. Each tine 104 is connected at fixed support 106 by a pivot coupling 108, and is connected at a moving support 110 by a pivot coupling 112. Pivot coupling 112 is made a end 114 of tine 104, and pivot coupling 108 is made at spaced inward distance on the tine from end 114. The opposite end 116 of each tine is free. Support 110 is connected to a motor 118 and is driven by the motor to reciprocate back-and-forth causing each tine 104 to pivot about pivot coupling 108 and swing back-and-forth in a sweeping motion. Moving support 110 can be connected to motor 118 by conventional linkage 120 for transforming rotational motion into linear reciprocation motion. For example, linkage 120 may include a disc 122 connected to shaft 124 of the motor 118 to be rotatingly driven. A link 126 is pivotally connected at one end to disc 112 at an eccentric position, and is pivotally connected at the opposite end to moving support 110. To this end, moving support 110 is connected to motor 118 through linkage 120 and rotational output of the motor is transformed into reciprocal motion of the moving support 110. In operation, the vertical surfaces and ends 116 of tines 104 act against the animal waste breaking the animal waste up to be flushed away.

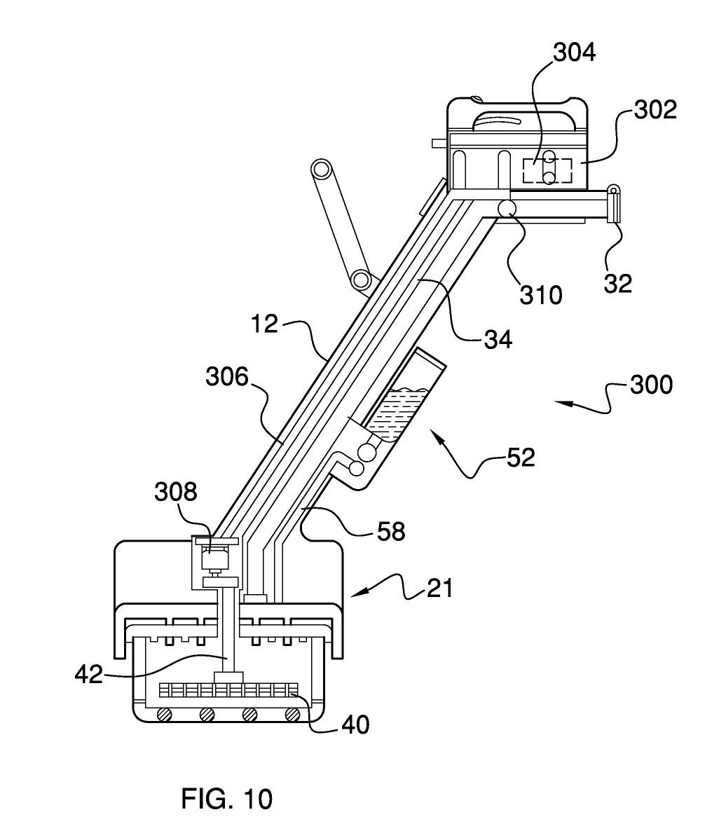

A third embodiment of the pet waste removal device 300 of the invention will be described below with reference to FIG. 10. The same reference numbers, as employed in the first embodiment, will refer to the same parts, and explanation thereof in detail will be omitted here. FIG. 10 is a diagrammatic, and partial cross-sectional, side elevation view of the third embodiment of the pet waste removal device 300. In the first embodiment, electrical power is provided to the pet waste removal device 10 by power supply 66. As discussed above, power supply 66 can be provided in the form of one or more batteries, a battery pack or an electrical cord plugged into an electrical outlet. In the third embodiment, power supply 66 is replaced by a combustion engine 302 driving coupled to an electric generator unit 304 to provide necessary electrical power to the various electrically operated components of the pet waste removal device 300. Electric cabling 306 couples motor 308 to the electrical generator 304. Valve 310 replaces valve 36 of the prior embodiments. The third embodiment, is configured similarly to a conventional vegetation line trimmer.

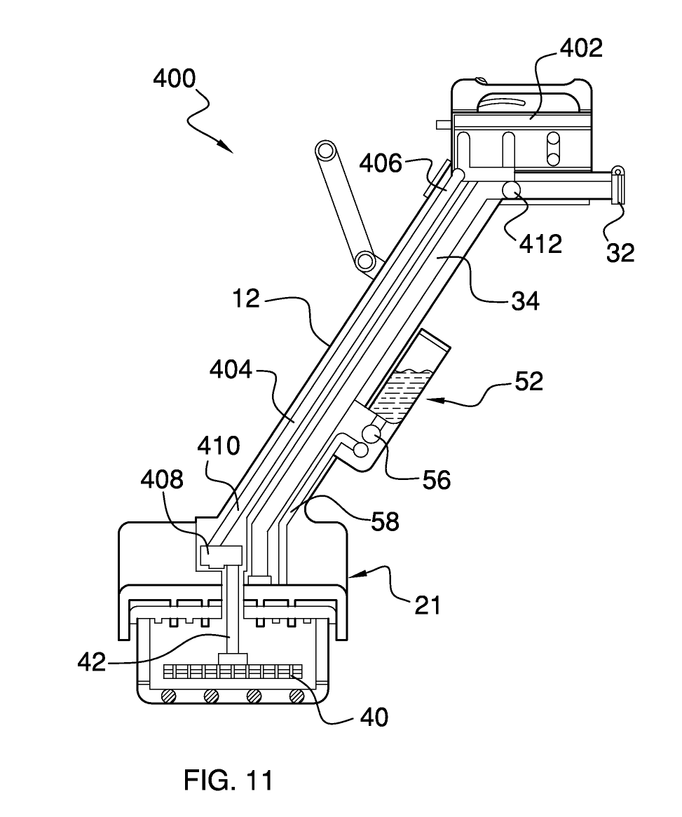

A fourth embodiment of the pet waste removal device 400 of the invention will be described below with reference to FIG. 11. The same reference numbers, as employed in the first embodiment, will refer to the same parts, and explanation thereof in detail will be omitted here. FIG. 11 is a diagrammatic, and partial cross-sectional, side elevation view of the third embodiment of the pet waste removal device 400. In the fourth embodiment, combustion engine 402 is provided and is driving coupled to an electric generator unit 404 to provide necessary electrical power to the various electrically operated components, including pump 56. In this embodiment, a drive shaft 404 extends the length of the boom 12 and is operatively connected to the combustion engine 402 at one end 406 to be drivingly rotated, and is operatively connected to a gear box 408 at the opposite end 410. Gear box 408 is operatively connected to shaft 42 to rotate the same, and thus the agitator 40. Valve 412 replaces valve 36 of the prior embodiments. The third embodiment, is configured similarly to a conventional vegetation line trimmer

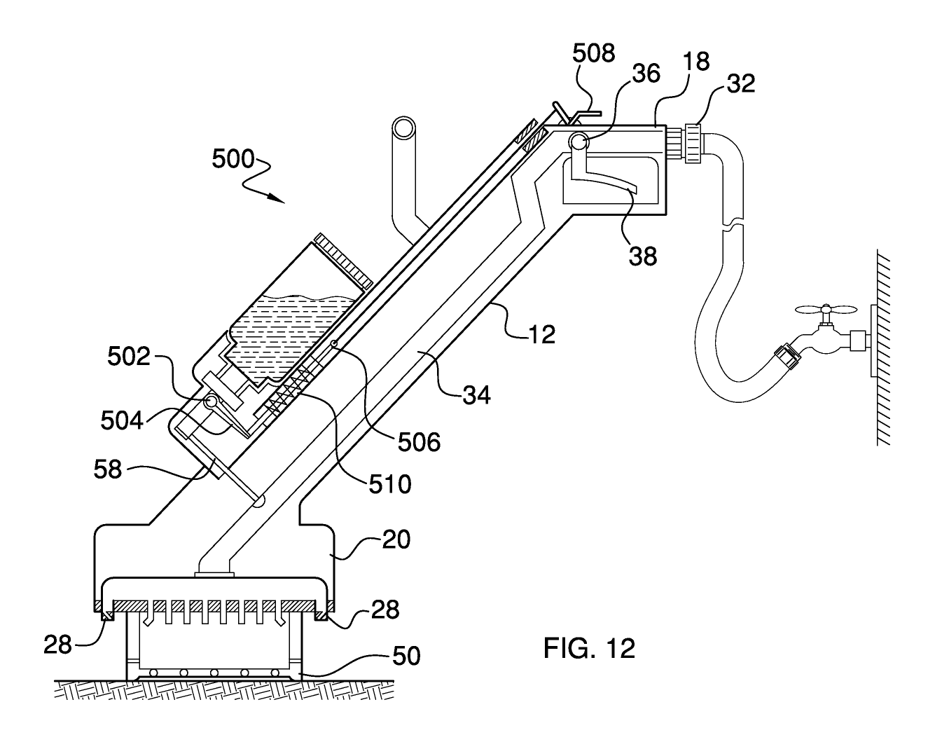

A fifth embodiment of the pet waste removal device 500 of the invention will be described below with reference to FIG. 12. The same reference numbers, as employed in the first embodiment, will refer to the same parts, and explanation thereof in detail will be omitted here. FIG. 12 is a diagrammatic illustration of an device 500 of the invention. In device 500, the electrically operated pump 56 is replaced by a manually operated pump 502 and the treatment solution fluid passage 58 is connected to fluid passage 34, which further illustrates an alternative construction as discussed above. Pump handle 504 extends from the pump 502 and is connected to one end of a control rod 506. A control lever 508 is connected to the opposite end of the control rod 506 and is operated to reciprocate the control rod 506 and actuate the pump 502 to pump fluid disinfectant and/or deodorizer from the fluid dispenser 52 and through the treatment solution fluid passage 58 where it is admixed with water flowing through fluid passage 34. A biasing spring 510 may be included to bias the control rod 506 in one direction. Further, device 500 does not is not shown to include the agitator or agitator driver as in the previous embodiments, but may include the same.

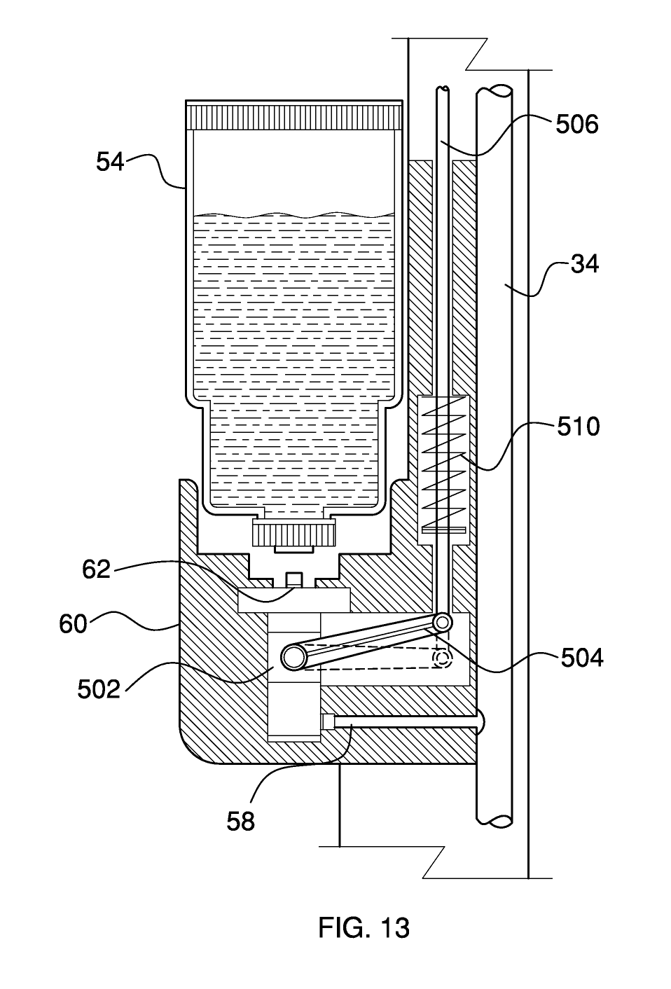

FIG. 13 is an enlarged, partial diagrammatic illustration of dispenser 52 and pump 502 of apparatus 500. The container 54 is illustrated exploded from the cradle 60. The pump handle 504 is illustrated in an upper most position and a lower most position (shown in broken line).

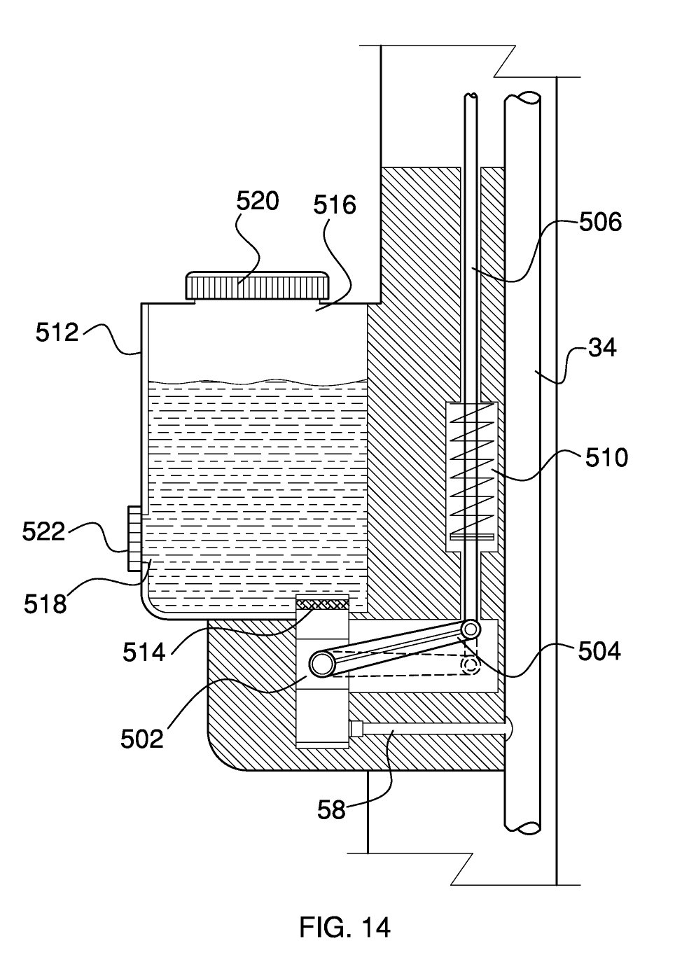

FIG. 14 is an enlarged, partial diagrammatic illustration of the apparatus of 500 illustrating an alternative container 512 that is integrated with the boom 12. A filter screen 514 is disposed at the inlet of the pump 502, and the container 512 is provided with a fill opening 516 and a drain opening 518 that are each sealed by removable caps 520 and 522, respectively.

Additionally, the pump handle 504 is illustrated in an upper most position and a lower most position (shown in broken line).

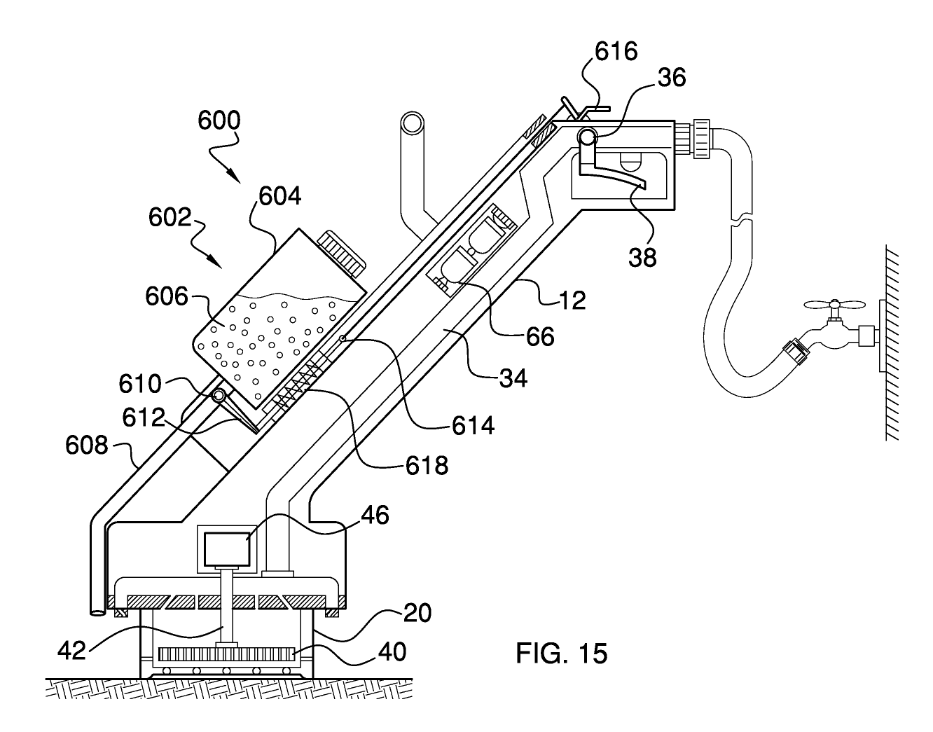

A sixth embodiment of the pet waste removal device 600 of the invention will be described below with reference to FIG. 15. The same reference numbers, as employed in the first embodiment, will refer to the same parts, and explanation thereof in detail will be omitted here. FIG. 15 is a diagrammatic, and partial cross-sectional, side elevation view of the sixth embodiment of the pet waste removal device 600. In device 600, dispenser 52 is eliminated and a dispenser 602 is included. Dispenser 602 is configured to dispense a granular chemical material at a location external of the plenum 20. Dispenser 602 includes a container 604 supported by boom 12 and adapted to receive and hold a quantity of granular material 606. A discharge conduit 608 extends from the container 604 and terminates at an open end approximate the side of the plenum with the open end facing generally downwardly. The granular material 606 is free to flow from the container through the discharge conduit 608 under the force of gravity. The flow of granular material 606 through discharge conduit 608 is controlled by valve 610 disposed across the discharge conduit. Valve arm 612 extends from valve 610 is connected to one end of a control rod 614. The opposite end of the control rod 614 is connected to a control lever 616. Control lever 616 is operated to open and close valve 610 by reciprocating the control rod 614. A biasing spring 618 may be provided to bias the control rod 614 in one direction, such that valve 610 is normally closed.

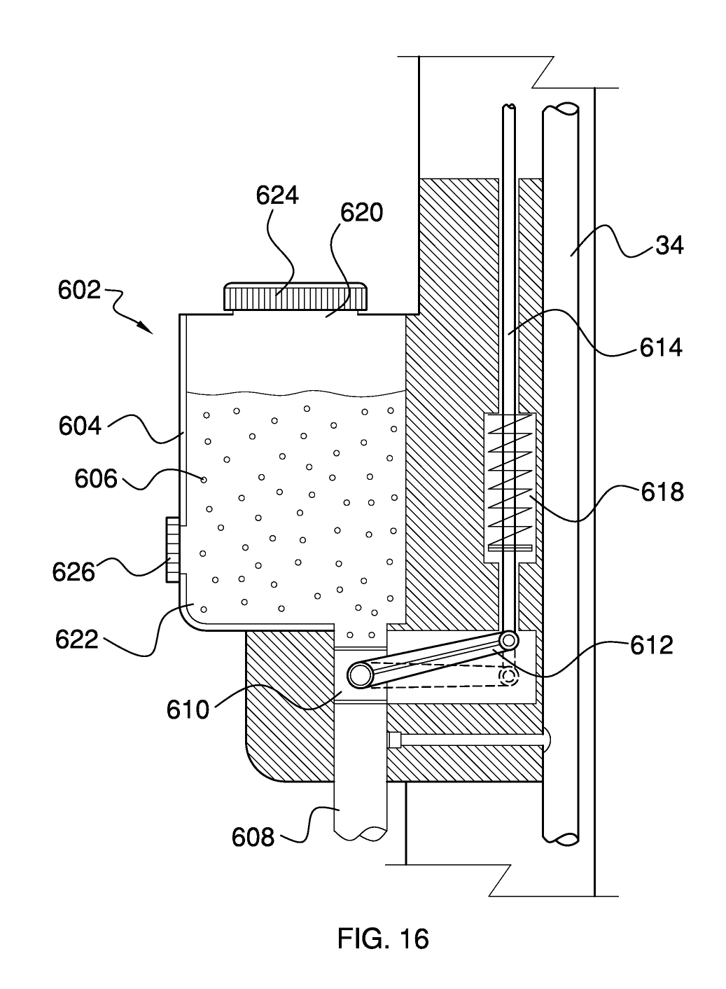

FIG. 16 is an enlarged, partial diagrammatic illustration of dispenser 602 of apparatus 500 further showing the container 604, the valve 610, the discharge conduit 608, valve arm 612, control rod 614 and spring 618. Container 604 may be provided with a fill opening 620 and a drain opening 622 that are each sealed by removable caps 624 and 626, respectively.

A number of embodiments of the present invention have been described. Nevertheless, it will be understood that various modifications may be made without departing from the spirit and scope of the invention.

1. An apparatus for removing animal waste from a surface, comprising:
a boom configured to be grasped by an operator at one end;
a cleaning head attached to said boom, said cleaning head having a plenum with an open bottom, said open bottom facing in a direction away from said boom;
a material agitator disposed within said plenum;
an agitator driving assembly connect to said material agitator and operable to drive said material agitator;
a fluid passage configured to be connected to a supply of pressurized fluid;
a plurality of outlet nozzles arranged along said plenum and configured to dispense fluid flowing through said fluid passage;
a fluid dispenser fluidically connected to said plurality of outlet nozzles; and
a pump operatively connected to said fluid dispenser and operable to pump fluid contained by said fluid dispenser through said plurality of outlet nozzles.

2. The apparatus of claim 1 wherein said plurality of outlet nozzles include one or more outlet nozzles arrange within said plenum and to dispense fluid towards said open bottom.

3. The apparatus of claim 2, wherein said plurality of outlet nozzles include one or more outlet nozzle arranged exteriorly of said plenum and to dispense fluid towards said plenum.

4. The apparatus of claim 1, wherein said material agitator is driven by said agitator driving assembly for rotation about an axis extending through said open bottom.

5. The apparatus of claim 1, further comprising:
a valve disposed across said fluid passage; and
a control lever operatively connected to said valve and operable to open or close said valve to control the flow of fluid through said fluid passage, said control lever disposed to be grasped by an operator while grasping said boom.

6. The apparatus of claim 5, wherein said fluid dispenser comprises:
a fluid container; and
said apparatus further includes a cradle adapted to removably attach said fluid container to said boom by mutual engagement between said fluid container and said cradle.

7. The apparatus of claim 1, wherein said fluid dispenser comprises:
a fluid container; and
said apparatus further includes a cradle adapted to removably attach said fluid container to said boom by mutual engagement between said fluid container and said cradle.

8. The apparatus of claim 1, wherein said agitator comprises:
a plurality of vertically oriented and horizontally spaced tines each connected at fixed support by a pivot coupling and connected at a moving support by a pivot coupling.

9. The apparatus of claim 1, wherein said pump is an electrical pump.

10. The apparatus of claim 1, wherein said pump is a manual pump.

11. The apparatus of claim 1, wherein said agitator driving assembly includes an electric motor and said apparatus further includes a power supply connectable to said electric motor to provide electrical power to operate said electric motor.

12. The apparatus of claim 1, wherein said agitator is disposed entirely within said plenum.

13. An apparatus for removing animal waste from a surface, comprising:
a boom configured to be grasped by an operator at one end;
a cleaning head attached to said boom, said cleaning head having a plenum with an open bottom, said open bottom facing in a direction away from said boom;
a material agitator disposed entirely within said plenum;
an agitator driving assembly including an electric motor connect to said material agitator and operable to drive said material agitator;
a power supply electrically connected to said electric motor;
a fluid passage configured to be connected to a supply of pressurized fluid;
a valve disposed across said fluid passage and operable to permit the flow of fluid through said fluid passage or to preclude the flow of fluid through said fluid passage;
a control lever operatively connected to said valve and operable to open or close said valve to control the flow of fluid through said fluid passage, said control lever disposed to be grasped by an operator while grasping said boom;
a plurality of outlet nozzles arranged along said plenum and configured to dispense fluid flowing through said fluid passage;
a fluid dispenser fluidically connected to said plurality of outlet nozzles; and
a pump operatively connected to said fluid dispenser and operable to pump fluid contained by said fluid dispenser through said plurality of outlet nozzles.

14. The apparatus of claim 13 wherein said plurality of outlet nozzles include one or more outlet nozzles arrange within said plenum and to dispense fluid towards said open bottom.

15. The apparatus of claim 13, wherein said plurality of outlet nozzles include one or more outlet nozzle arranged exteriorly of said plenum and to dispense fluid towards said plenum.

16. The apparatus of claim 13, wherein said material agitator is driven by said agitator driving assembly for rotation about an axis extending through said open bottom.

17. The apparatus of claim 1, wherein said fluid dispenser comprises:
a fluid container; and
said apparatus further includes a cradle adapted to removably attach said fluid container to said boom by mutual engagement between said fluid container and said cradle.

18. The apparatus of claim 1, wherein said agitator comprises:
a plurality of vertically oriented and horizontally spaced tines each connected at fixed support by a pivot coupling and connected at a moving support by a pivot coupling.

19. The apparatus of claim 1, wherein said pump is an electrical pump.

20. The apparatus of claim 1, wherein said pump is a manual pump.

21. An apparatus for removing animal waste from a surface, comprising:
a boom configured to be grasped by an operator at one end;
a cleaning head attached to said boom, said cleaning head having a plenum with an open bottom, said open bottom facing in a direction away from said boom;
a material agitator disposed within said plenum;
an agitator driving assembly connect to said material agitator and operable to drive said material agitator;
a fluid passage configured to be connected to a supply of pressurized fluid;
a plurality of outlet nozzles arranged along said plenum and configured to dispense fluid flowing through said fluid passage;
a granular material dispenser carried by said boom configured to discharge a quantity of granular material at a location exteriorly of said plenum.
